(19) United States
(12) Patent Application Publication
(10) Pub. No.: US 2025/0308218 A1
(43) Pub. Date: Oct. 2, 2025

(54) IMAGE INSPECTION APPARATUS

(71) Applicant: Keyence Corporation, Osaka (JP)

(72) Inventor: Yasuhisa IKUSHIMA, Osaka (JP)

(73) Assignee: Keyence Corporation, Osaka (JP)

(21) Appl. No.: 19/066,206

(22) Filed: Feb. 28, 2025

(30) Foreign Application Priority Data
Mar. 28, 2024 (JP) 2024-054857

(51) Int. Cl. G06V 10/774; G06T 7/00; G06V 10/94

(52) U.S. Cl. CPC G06V 10/774; G06T 7/0004; G06V 10/945; G06T 2200/24; G06T 2207/20081; G06T 2207/20084; G06T 2207/20092; G06T 2207/30164; G06V 2201/06

(57) ABSTRACT

An image inspection apparatus includes an inspection execution unit and a setting reception unit for accepting a setting related to inspection. When the setting reception unit accepts the setting for a first tool and a second tool, the setting reception unit displays a first image area a second image area, each of which corresponding to the first tool and the second tool with a single image. The setting reception unit accepts a designation of a first label and a second label, and learns a first model related to the first tool with a first dataset including a combination of the single image and the first label, and learns a second model related to the second tool with a second dataset including a combination of the single image and the second label.

### CROSS-REFERENCE TO RELATED APPLICATIONS

The present application claims foreign priority based on Japanese Patent Application No. 2024-054857, filed Mar. 28, 2024, the contents of which are incorporated herein by reference.

### BACKGROUND OF THE INVENTION

### 1. Technical Field

This disclosure relates to an image inspection apparatus.

### 2. Description of the Related Art

For example, JP2023-77051A discloses an image inspection apparatus that inputs inspection target images into a machine learning model trained with non-defective product images and defective product images, and performs pass/fail judgment on the inspection target images.

In the image inspection apparatus of JP2023-77051A, defective information is input using either a first annotation method that assigns a label indicating whether the displayed image is a non-defective product image or a defective product image, or a second annotation method that specifies the defective areas of the defective product images, and the learning of the machine learning model is executed using the annotated images.

In the image inspection apparatus of JP2023-77051A, defective information can be input using either the first annotation method or the second annotation method, and the parameters of the machine learning model can be adjusted based on that defective information, thereby reducing the user's effort during the learning process.

### SUMMARY OF THE INVENTION

However, a large number of learning images are required for training the machine learning model, and generally, it was difficult to prepare a large number of learning images for which annotation (labeling) is to be performed.

Moreover, the inspection target image often includes multiple judgment areas determined by the machine learning model, and if all of these multiple judgment areas are determined to be non-defective, the inspection target image is judged to be a non-defective product image as an overall judgment, while if even one of these multiple judgment areas is determined to be defective, the inspection target image is judged to be a defective product image as an overall judgment.

The judgment area by the machine learning model in the inspection target image is the execution area of the AI tool, and for example, in a method of annotating the learning image itself as a non-defective product image or a defective product image as in JP2023-77051A, it is necessary to register the learning image as a non-defective product image or a defective product image for each AI tool, making it difficult for the user to label accurately.

For example, if there is a defective part in a part of the work of the learning image, that learning image is a defective product image; however, if another part is in a non-defective product state, it is necessary to register that non-defective product state part as a non-defective product image for the AI tool that inspects it, which increases the difficulty of labeling due to the divergence from the user's intuition.

The present disclosure is made in consideration of such points, and one objective of certain embodiments is to simplify user labeling when multiple inspection points are included in a single learning image, as well as to enable efficient learning.

According to one embodiment, an image inspection apparatus includes: an imaging unit configured to capture an image, an inspection execution unit configured to execute an inspection program for the image captured by the imaging unit, and a setting reception unit configured to accept a setting related to the inspection program.

The setting reception unit, when the setting reception unit accepts the setting related to the inspection program that includes a first tool executed on a first image area of the image and a second tool executed on a second image area different from the first image area, displays a setting screen that includes a target image area configured to display the first image area corresponding to the first tool and the second image area corresponding to the second tool based on a single image as the image, in a manner that the first image area and the second image area are specifiable, and a label information area configured to display information of a first label corresponding to the first image area and information of a second label corresponding to the second image area, accepts a designation of the first label related to the first image area, accepts a designation of the second label related to the second image area, executes learning of a first model related to the first tool with a first dataset including a combination of the single image and the first label, and executes learning of a second model related to the second tool with a second dataset including a combination of the single image and the second label.

According to this configuration, when accepting settings related to an inspection program in which the first tool and the second tool are executed for the first image area and the second image area of a single image, respectively, it is possible to accept the designation of the first label related to the first image area and the designation of the second label related to the second image area, so that individual labeling for the first image area and the second image area can be easily performed. After labeling the first image area and the second image area, the learning of the first model is executed with a first dataset that includes a combination of the single image and the first label, and the learning of the second model is executed with a second dataset that includes a combination of the single image and the second label, so that the single image can be used for the learning of both the first model and the second model, enabling efficient learning.

As described above, when multiple inspection points are included in a single image, labeling by the user becomes easier, and efficient learning can be performed using a single image.

### BRIEF DESCRIPTION OF THE DRAWINGS

FIG. 1 is a schematic diagram showing the configuration of the image inspection apparatus according to an embodiment of the present disclosure.

FIG. 2 is a block diagram showing the hardware configuration of the image inspection apparatus.

FIG. 3 is a diagram explaining an example of processing a workpiece image with a pre-trained model.

FIG. 4 is a diagram showing examples of non-defective product images and defective product images.

FIG. 5 is a diagram showing an example of learning images for learning the model of the first tool.

FIG. 6 is a diagram showing an example of an image that is judged as non-defective by the first tool and judged as defective by the second tool and the third tool.

FIG. 7 is a diagram showing another example of non-defective product images and defective product images.

FIG. 8 is a diagram showing an example of a conventional learning method when judging the same part.

FIG. 9 is a diagram showing an example of a user interface screen for batch labeling and batch learning.

FIG. 10 is a diagram showing an example of a property screen.

FIG. 11 is a diagram explaining an example of judgment when sharing a model.

FIG. 12 is a diagram explaining a case of executing additional learning for the first model from another tool.

FIG. 13 is a diagram showing an example of a dataset of the first tool.

FIG. 14 is a diagram showing an example of a user interface screen for accepting labeling of non-defective products and defective products for each tool.

FIG. 15 is a diagram showing an example of a message dialog displayed when sharing a model.

### DETAILED DESCRIPTION

The following describes in detail the embodiments of the present disclosure based on the drawings. The description of the preferred embodiments below is essentially illustrative and is not intended to limit the present disclosure, its applications, or its uses.

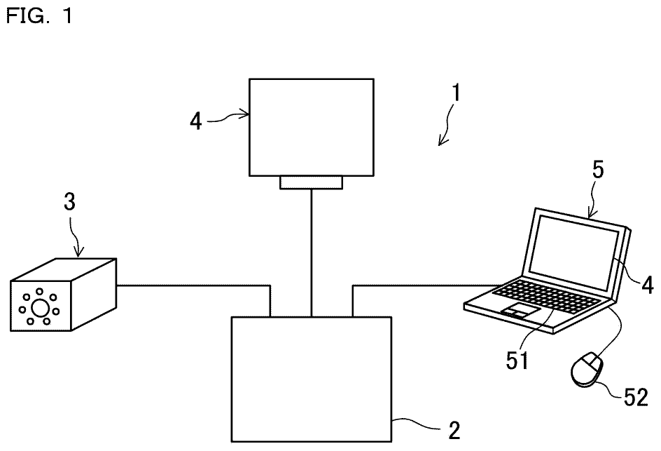

FIG. 1 is a schematic diagram showing the configuration of the image inspection apparatus 1 according to an embodiment of the present disclosure. The image inspection apparatus 1 is a device for determining the quality of workpiece images obtained by capturing a work that is an inspection target, such as various parts or products, and can be used in production sites such as factories. Specifically, the image inspection apparatus 1 is capable of executing a machine learning model, which is generated by learning non-defective product images corresponding to non-defective products and defective product images corresponding to defective products. The generated machine learning model can input a workpiece image (also referred to as an input image) captured from the inspection target work and determine the quality of the workpiece image using the machine learning model. Since the image inspection apparatus 1 inspects the appearance of the work, it can also be referred to as an appearance inspection apparatus.

The work may be the entire inspection target, or only a part of the work may be the inspection target. Furthermore, multiple inspection targets may be included in one work. Additionally, the workpiece image may include multiple works.

The image inspection apparatus 1 includes a control unit 2 that serves as the main body of the apparatus, an imaging unit 3, a display device (display unit) 4, and a personal computer 5. The personal computer 5 is not essential and can be omitted. Instead of the display device 4, the personal computer 5 can be used to display various information and images, or the functions of the personal computer 5 can be incorporated into the control unit 2 or the display device 4.

In FIG. 1, as an example of the configuration of the image inspection apparatus 1, the control unit 2, the imaging unit 3, the display device 4, and the personal computer 5 are described, and any combination of these can be integrated. For example, the control unit 2 and the imaging unit 3 can be integrated, or the control unit 2 and the display device 4 can be integrated. In addition, the control unit 2 can be divided into multiple units, with part of it incorporated into the imaging unit 3 or the display device 4, or the imaging unit 3 can be divided into multiple units, with part of it incorporated into other units.

### (Configuration of Imaging Unit 3)

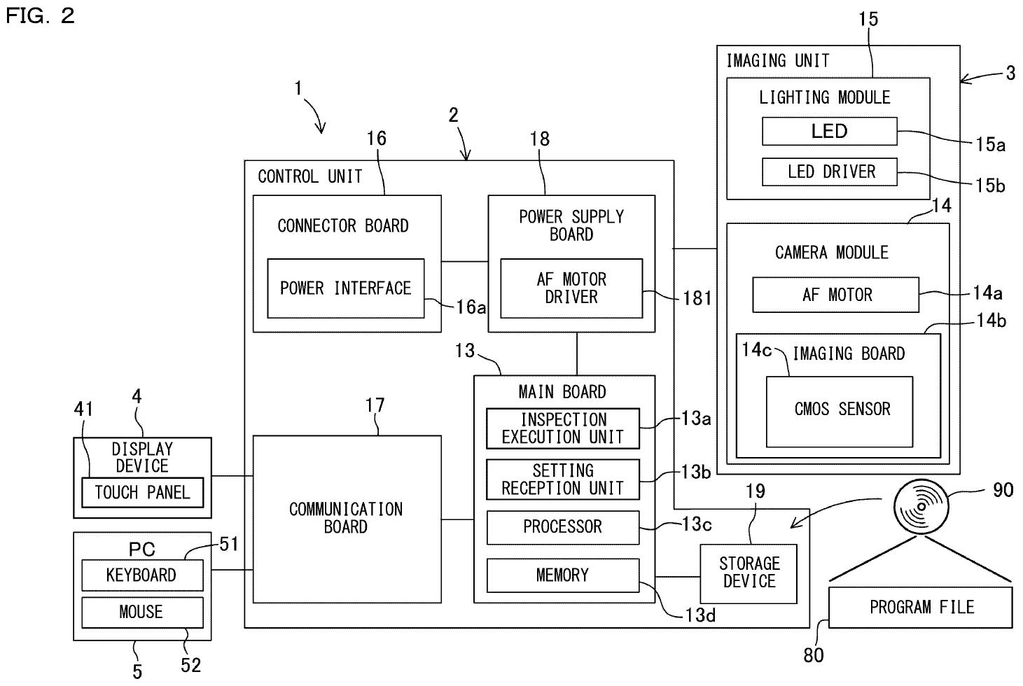

As shown in FIG. 2, the imaging unit 3 is a unit that includes a camera module (imaging part) 14 and a lighting module (lighting part) 15, and performs imaging of a workpiece and generates image data. The image data generated by the imaging unit 3 may contain a string composed of multiple characters in one or more lines, depending on the type of workpiece. The camera module 14 includes an AF motor 14a that drives the imaging optical system and an imaging board 14b. The AF motor 14a is a part that automatically performs focus adjustment by driving the lens of the imaging optical system, and can perform focus adjustment using methods such as the well-known contrast autofocus. The imaging board 14b is equipped with a CMOS (Complementary Metal Oxide Semiconductor) sensor 14c as a light-receiving element that receives light incident from the imaging optical system. The CMOS sensor 14c is an imaging sensor configured to acquire color images. Instead of the CMOS sensor 14c, a light-receiving element such as a CCD (Charge-Coupled Device) sensor can also be used.

The lighting module 15 includes an LED (light-emitting diode) 15a as a light-emitting element that illuminates the imaging area including the work, and an LED driver 15b that controls the LED 15a. The light emission timing, light emission duration, and light emission amount of the LED 15a can be arbitrarily controlled by the LED driver 15b. The LED 15a may be provided integrally with the imaging unit 3 or may be provided as an external lighting unit separately from the imaging unit 3.

### (Structure of Display Device 4)

Display device 4 has a display panel made of, for example, a liquid crystal panel or an organic EL (organic electro-luminescence) panel, and is controlled by the inspection execution unit 13a, setting reception unit 13b, processor 13c, etc. of control unit 2. Data such as workpiece images output from control unit 2 and various user interface screens are output to display device 4 and displayed as images on display device 4. In addition, when personal computer 5 has a display panel, the display panel of personal computer 5 can be used in place of display device 4.

### (Operation Device)

As an operation device for the user to operate the image inspection apparatus 1, examples include the keyboard 51 and mouse 52 of the personal computer 5; however, it is not limited to these, and any device configured to accept various operations by the user is acceptable. For example, a pointing device such as the touch panel 41 of the display device 4 is also included as an operation device.

User operations using the keyboard 51 and mouse 52 can be detected by the control unit 2. In addition, the touch panel 41 is a conventionally known touch-type operation panel equipped with, for example, a pressure-sensitive sensor, and the user's touch operation can be detected by the control unit 2. The same applies when using other pointing devices.

### (Structure of Control Unit 2)

Control unit 2 includes a main board 13, a connector board 16, a communication board 17, and a power supply board 18. The main board 13 is provided with an inspection execution unit 13a, a setting reception unit 13b, a processor 13c, and a memory 13d. The inspection execution unit 13a, which will be described in detail later, is the part that executes the inspection program for the images captured by the camera module 14. The setting reception unit 13b is the part that accepts settings related to the inspection program executed by the inspection execution unit 13a and can generate user interface screens, etc., for accepting settings related to the inspection program. The setting reception unit 13b can also be referred to as a UI (user interface) generation unit. Various user interface screens generated by the setting reception unit 13b are displayed on the display device 4.

The inspection execution unit 13a and the setting reception unit 13b can be configured by, for example, a processing device mounted on the main board 13 or software executed by the processing device. Furthermore, the inspection execution unit 13a, the setting reception unit 13b, and the processor 13c may be configured by a single processing device, or they may be configured by separate processing devices. Among the hardware constituting the inspection execution unit 13a, the setting reception unit 13b, and the processor 13c, part of it may be provided in the control unit 2, while the other may be provided separately from the control unit 2.

The inspection execution unit 13a, the setting reception unit 13b, and the processor 13c control the operation of each board and module that are connected. For example, the processor 13c outputs a lighting control signal that controls the lighting and extinguishing of the LED 15a to the LED driver 15b of the lighting module 15. The LED driver 15b switches the lighting and extinguishing of the LED 15a and adjusts the lighting time in accordance with the lighting control signal from the processor 13c, as well as adjusts the light intensity of the LED 15a.

The processor 13c outputs an imaging control signal to the imaging board 14b of the camera module 14 to control the CMOS sensor 14c. The CMOS sensor 14c starts imaging in response to the imaging control signal from the processor 13c and performs imaging by adjusting the exposure time to an arbitrary duration. That is, the imaging unit 3 captures the field of view of the CMOS sensor 14c according to the imaging control signal output from the processor 13c, and if a workpiece is within the field of view, it will capture the workpiece; however, if there are other objects within the field of view, those can also be captured. For example, the image inspection apparatus 1 can capture images used as learning images of a pre-trained model by the imaging unit 3. The learning images do not necessarily have to be images captured by the imaging unit 3, and can also be images captured by other cameras.

The setting reception unit 13b can not only generate and display a user interface screen on the display device 4, but also accept various operations by the user. For example, when the user operates an operation device such as a keyboard 51 or a mouse 52, the setting reception unit 13b detects the operation state. By accepting operations of various buttons displayed on the display device 4 and input operations such as characters by the setting reception unit 13b, the user's operations are reflected in the operation of the image inspection apparatus 1.

During the operation of the image inspection apparatus 1, the imaging unit 3 can capture the workpiece. Furthermore, the CMOS sensor 14c is configured to output a live image, that is, the currently captured image, at a short frame rate as needed.

When the imaging by the CMOS sensor 14c is completed, the image signal output from the imaging unit 3 is input to the processor 13c of the main board 13 for processing, and is stored in the memory 13d of the main board 13. It should be noted that the main board 13 may be provided with a processing device such as an FPGA (Field Programmable Gate Array) or a DSP (Digital Signal Processor). Furthermore, it may be a processor 13c in which processing devices such as FPGA or DSP are integrated.

The connector board 16 is a part that receives power supply from the outside via a power connector provided at the power interface 16a (not shown). The power board 18 is a part that distributes the power received by the connector board 16 to each board and module, specifically distributing power to the lighting module 15, camera module 14, main board 13, and communication board 17. The power board 18 is equipped with an AF motor driver 181. The AF motor driver 181 supplies driving power to the AF motor 14a of the camera module 14, realizing autofocus. The AF motor driver 181 adjusts the power supplied to the AF motor 14a according to the AF control signal from the processor 13c of the main board 13.

The communication board 17 is a part that executes communication between the main board 13 and the display device 4 and the personal computer 5, as well as communication between the main board 13 and external control devices (not shown). The external control device can include, for example, a programmable logic controller (PLC). The communication may be wired or wireless, and either communication form can be realized by a conventionally known communication module.

The control unit 2 is provided with a storage device (storage unit) 19 made of, for example, a solid state drive, hard disk drive, etc. The storage device 19 stores program files 80 and setting files (software) that enable the execution of the various controls and processes described later by the above hardware. The program files 80 and setting files can be stored on a storage medium 90 such as an optical disk, and the program files 80 and setting files stored on this storage medium 90 can be installed in the control unit 2. The program files 80 may also be downloaded from an external server using a communication line. In addition, the storage device 19 can also store parameters for constructing the pre-trained model of the image inspection apparatus 1, such as the above image data.

The storage device 19 may be provided outside the control unit 2 and may be constituted by a so-called cloud storage or the like. In addition, the storage device 19 may be constituted by the storage device of the personal computer 5.

### (Pre-Trained Model)

The image inspection apparatus 1 of this embodiment is configured to be capable of executing both image inspection according to predetermined rules and image inspection using a pre-trained model, but is not limited to this, and may also be capable of executing only image inspection using a pre-trained model. Image inspection according to predetermined rules can be referred to as rule-based image inspection. A tool that performs image inspection according to predetermined rules is referred to as a rule-based tool, and the rule-based tool includes, for example, a preprocessing tool that adjusts the contrast of the workpiece image, a position correction tool that corrects the position and posture of the work, a dimension geometry tool that extracts the dimensions and geometric shapes of the work, and a defect tool that extracts defects on the external surface of the work.

On the other hand, image inspection using a pre-trained model can be referred to as AI-based image inspection that enables image inspection by training a machine learning model with training images and teacher data. In image inspection using a pre-trained model, first, a pre-trained model is generated by inputting multiple training images and teacher data into the machine learning model for training. The pre-training of the machine learning model can be performed before the operation of the image inspection apparatus 1, and it may be done at the time of factory shipment of the image inspection apparatus 1, or after the factory shipment of the image inspection apparatus 1 and before its operation.

During the operation of the image inspection apparatus 1, an image is input to the pre-trained model, and processing such as classification processing, determination processing, detection processing, and positioning processing is executed by the pre-trained model. A tool that indicates image processing using the pre-trained model is called a machine learning tool (AI tool), and the machine learning tool includes a determination tool that indicates determination processing to determine the quality of the input image by the pre-trained model, a character recognition processing tool (OCR tool) that recognizes characters contained in the image of the input image data, a classification tool that indicates classification processing to classify the input image into one of multiple classes by the pre-trained model, a detection tool that indicates detection processing to detect objects and defects contained in the input image by the pre-trained model, and a positioning tool that indicates positioning processing to position objects contained in the input image by the pre-trained model.

By pre-training the machine learning model, the parameters of the machine learning model are changed. The changed parameters can be stored, for example, in the storage device 19. During the operation of the image inspection apparatus 1, the parameters stored in the storage device 19 are read by the processor 13c and the inspection execution unit 13a, making the pre-trained model executable by the processor 13c and the inspection execution unit 13a.

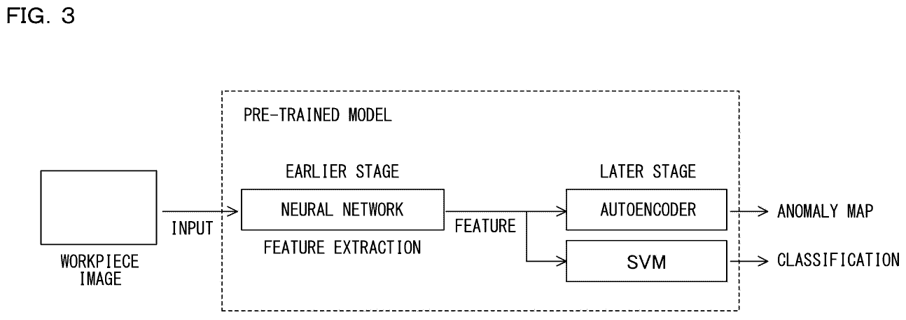

As shown in FIG. 3, the pre-trained model includes a neural network, an autoencoder, SVM (Support Vector Machine), and the like. The processor 13c and the inspection execution unit 13a input images into the neural network that has become executable as described above. This is processing in an earlier stage of the pretrained model. And, when an image is input into the neural network, the neural network performs feature extraction, and the extracted features are input to the autoencoder and/or support vector machine that perform processing in a later stage of the pretrained model. The neural network that performs feature extraction in the earlier stage may be a pre-trained convolutional neural network or a convolutional neural network configured to allow additional learning. Furthermore, in the pre-trained model shown in FIG. 3, multiple features (feature maps) of different scales are extracted from multiple layers of the convolutional neural network, and these multiple features may be configured to be input to the autoencoder and/or support vector machine respectively.

An autoencoder generates and outputs an anomaly map (heat map) based on the input features. On the other hand, a support vector machine forms a classifier that classifies images into multiple classes based on the input features, and when a new image is input, classification processing is performed by inputting it into this classifier. The machine learning model according to this embodiment is not limited to autoencoders or SVMs, and other machine learning models may also be used.

### (Annotation)

By inputting non-defective product images corresponding to non-defective products and defective product images corresponding to defective products into a machine learning model that can be executed by the image inspection apparatus 1 and training it, the parameters of the machine learning model can be adjusted. As a learning method, for example, a method can be adopted in which the parameters are adjusted while feeding back the errors of image recognition output from the machine learning model.

The user needs to specify whether the image input to the machine learning model is a non-defective product image or a defective product image, and if the image input to the machine learning model is a defective product image, where the defective area is located, prior to the training of the machine learning model. This is the annotation performed by the user themselves. Specifying whether it is a non-defective product image or a defective product image is also referred to as labeling.

### (AI Judgment Tool Details)

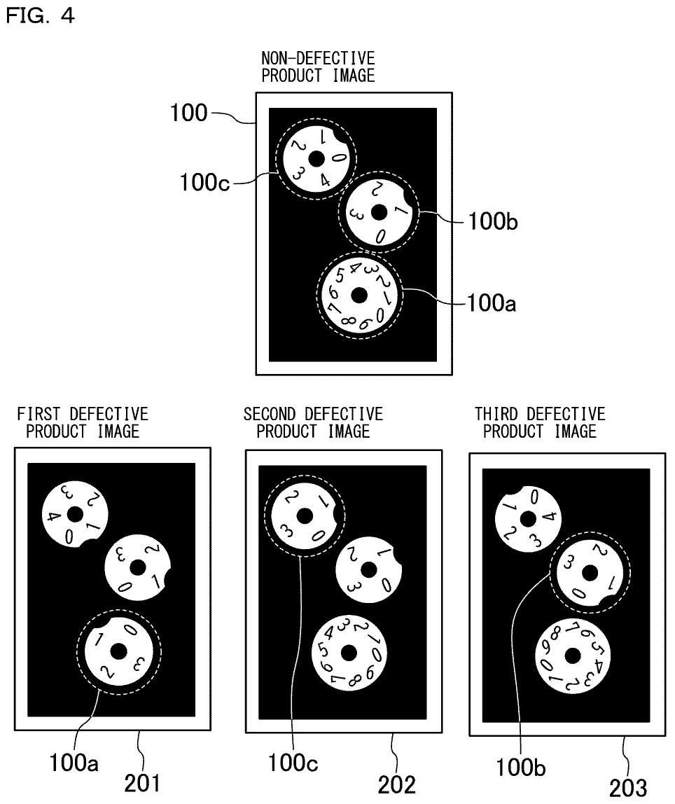

FIG. 4 is a diagram showing examples of non-defective product image 100, first defective product image 201, second defective product image 202, and third defective product image 203. Non-defective product image 100 is an image captured of a non-defective product workpiece. The three dials possessed by the workpiece are each inspection targets. In non-defective product image 100, a circular first image area 100a is set to include the dial located at the bottom, a circular second image area 100b is set to include the dial located in the middle, and a circular third image area 100c is set to include the dial located at the top. The AI judgment tool that determines the quality of the first image area 100a using a pre-trained model is referred to as the first tool, the AI judgment tool that determines the quality of the second image area 100b using a pre-trained model is referred to as the second tool, and the AI judgment tool that determines the quality of the third image area 100c using a pre-trained model is referred to as the third tool, which can be set by the setting reception unit 13b. Since the first, second, and third image areas are separated from each other, the first tool, second tool, and third tool will also be set apart from each other. The first tool, second tool, and third tool are included in the inspection program. When setting the first tool, second tool, and third tool, the setting operation by the user can be accepted by the setting reception unit 13b.

The first defective product image 201 is determined to be defective by the first tool because the dial located below is a defective area, but it is determined to be non-defective by the second tool and the third tool. The second defective product image 202 is determined to be defective by the third tool because the dial located above is a defective area, but it is determined to be non-defective by the first tool and the second tool. The third defective product image 203 is determined to be defective by the second tool because the dial located in the middle is a defective area, but it is determined to be non-defective by the first tool and the third tool.

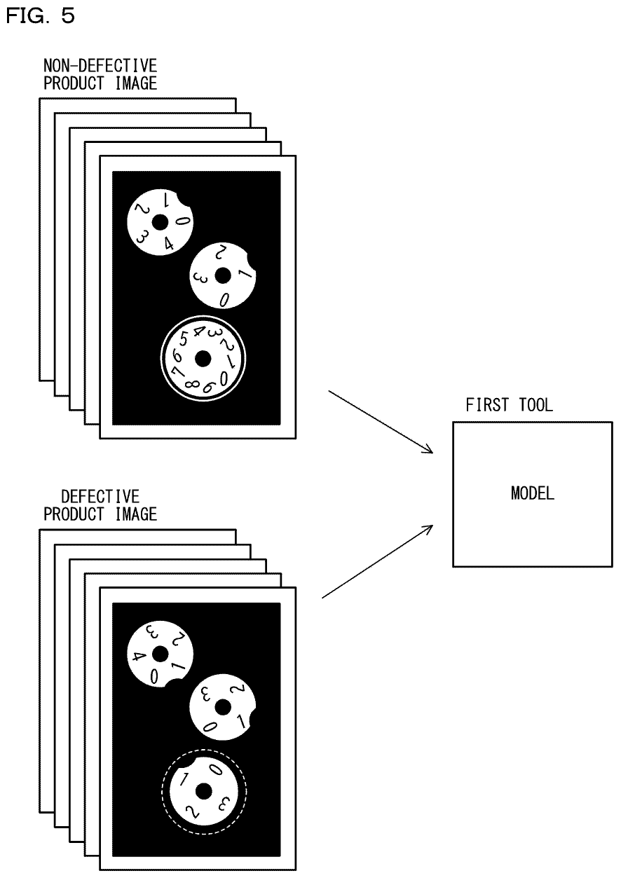

In this way, when three inspection points that are different from each other are included in a single image as the first, second, and third image regions, it is necessary to set the first tool, second tool, and third tool, so it is necessary to generate each model of the first tool, second tool, and third tool. As shown in FIG. 5, in order to generate the model of the first tool, it is necessary to prepare multiple non-defective product images and defective product images, respectively. The same applies to the second tool and the third tool.

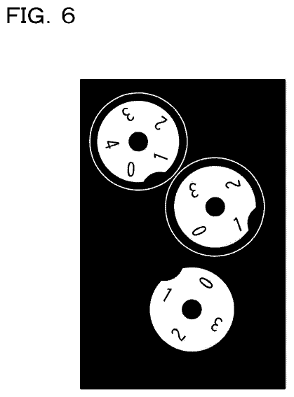

FIG. 6 shows an example of an image in which the lower dial is defective, while the upper dial and the intermediate dial are non-defective. The image in FIG. 6 can be used as a non-defective product image for the model related to the second tool, which judges the intermediate dial, and the model related to the third tool, which judges the upper dial. Since it is generally difficult to collect images that can be used as learning images, I would like to use the image in FIG. 6 not only for the learning of the model related to the first tool but also for the learning of the models related to the second tool and the third tool.

However, in the case of conventional annotation methods, when trying to annotate the image in FIG. 6, the lower dial is defective, so the entire image is labeled as a defective product image. Therefore, the image in FIG. 6 was not used in the learning of the second tool model and the third tool model.

In this embodiment, the image in FIG. 6 is used not only for the learning of the model related to the first tool but also for the learning of the models related to the second tool and the third tool. The details of this function will be described later, but it is referred to as batch labeling and batch learning function for a single image, and the image inspection apparatus 1 is configured to be capable of executing the batch labeling and batch learning function.

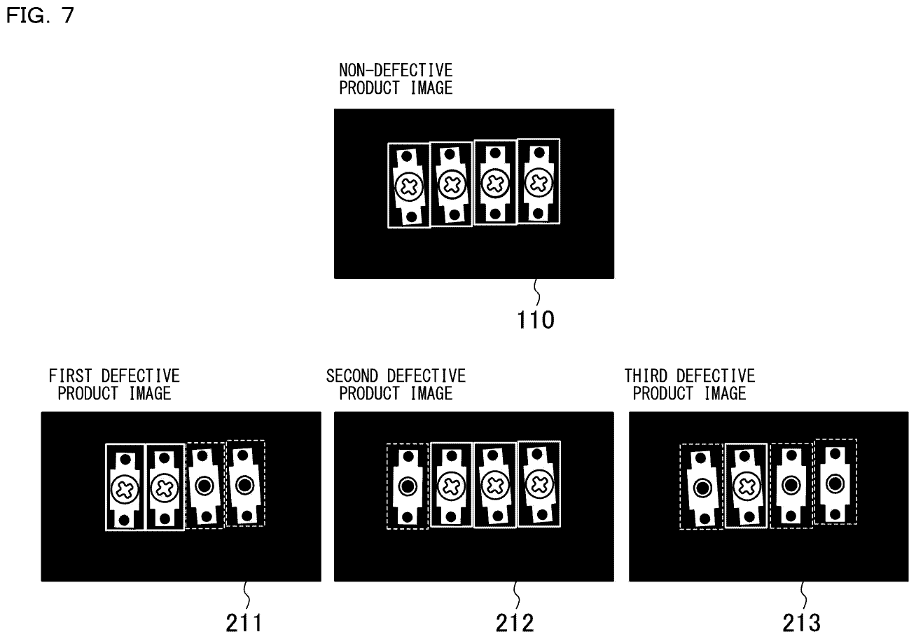

FIG. 7 is a diagram showing another example of non-defective product image and defective product image. In this example, a workpiece containing four fastening parts (parts fastened by screws) is included in one image, and all four fastening parts are the same. In the first defective product image 211, the two fastening parts on the left side are non-defective, and the two fastening parts on the right side are defective. In the second defective product image 212, the fastening part on the left end is defective, and the remaining three fastening parts are non-defective. In the third defective product image 213, the fastening part on the left end and the two fastening parts on the right side are defective, and the one fastening part on the right side is non-defective.

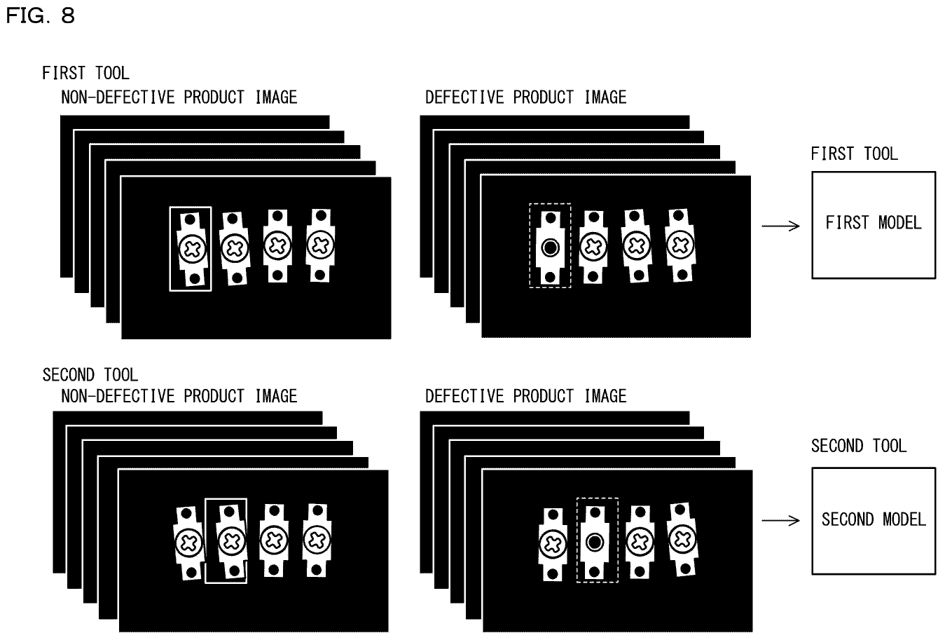

In the conventional setting method, since the non-defective product image 110 includes four fastening parts as inspection targets, four AI judgment tools (first tool, second tool, third tool, fourth tool) need to be set. FIG. 8 is a diagram explaining an example of the conventional learning method for the first tool and the second tool. In the conventional learning method, as shown in FIG. 8, multiple non-defective product images and defective product images are prepared respectively for learning the first model related to the first tool, as well as multiple non-defective product images and defective product images are prepared respectively for learning the second model related to the second tool. Therefore, since it is necessary to execute the learning of the first model and the learning of the second model, it has been cumbersome.

In this embodiment, it is noted that the first model related to the first tool and the second model related to the second tool are models that determine the same thing, and in the second tool, the judgment processing can be executed by referring to the first model. This function is called the model sharing function.

### (Batch Labeling and Batch Learning Function)

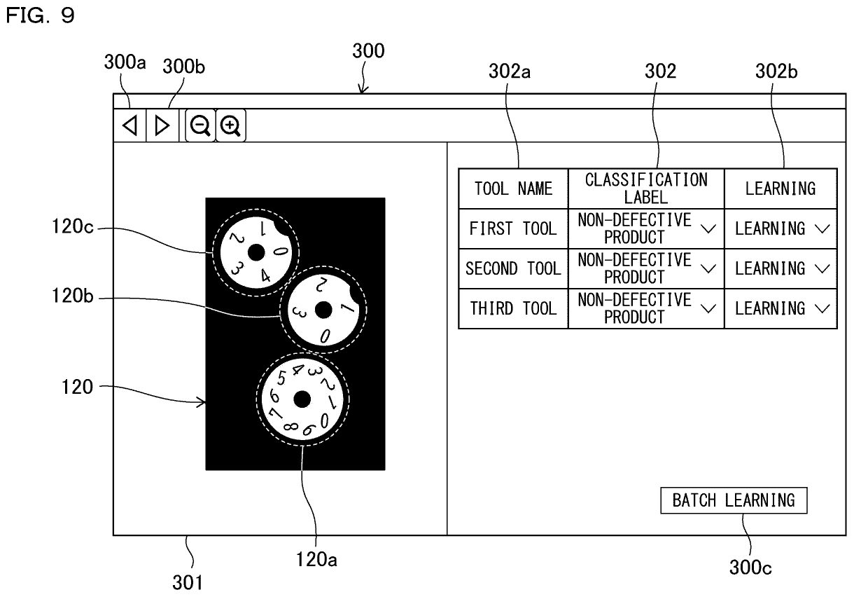

FIG. 9 is a diagram showing an example of a labeling user interface screen 300. The labeling user interface screen 300 is displayed on the display device 4 when the image inspection apparatus 1 executes the batch labeling and batch learning function. Specifically, when the image inspection apparatus 1 is in a setting mode that accepts various settings from the user, the setting reception unit 13b can accept settings related to the inspection program, including a first tool executed on the first image area 100a of the image and a second tool executed on a second image area 100b that is different from the first image area 100a. When the setting reception unit 13b accepts settings related to the inspection program that includes the first tool and the second tool, it generates the labeling user interface screen 300 and displays it on the display device 4.

The labeling user interface screen 300 includes a target image area 301 and a label information area 302. In the target image area 301, one learning image selected by the user, namely a single image 120, is displayed. The user can confirm whether the single image 120 displayed in the target image area 301 is the desired learning image or not.

A plurality of images are stored in the storage device 19, and the user can specify a learning image from the plurality of images stored in the storage device 19. Specifically, the labeling user interface screen 300 is provided with an image back button 300a and an image forward button 300b. When the setting reception unit 13b detects that the image back button 300a has been operated, it displays the previous image of the image currently displayed in the target image area 301 in the target image area 301. When the setting reception unit 13b detects that the image forward button 300b has been operated, it displays the next image of the image currently displayed in the target image area 301 in the target image area 301. As a result, the user can use the desired image as a learning image.

The setting reception unit 13b displays a first image area 120a corresponding to the first tool and a second image area 120b corresponding to the second tool in the target image area 301, based on a single image 120 in a manner that the first image area 120a and the second image area 120b are specifiable. The single image 120 displayed in the target image area 301 is an image used for training a first model related to the first tool executed on the first image area 120a. Therefore, the setting reception unit 13b displays the target image area 301 based on the image used for training the first model related to the first tool and displays the second image area 120b based on the image used for training the first model related to the first tool. In this embodiment, a third image area 120c corresponding to the third tool can also be displayed in a manner that the third image area 120c is distinguishable from the first image area 120a and the second image area 120b. The third tool is set as needed and may not require setting. Similarly, the fourth tool and the fifth tool can also be set.

The label information area 302 is provided with a tool name display area 302a and a learning setting area 302b that accepts settings for either learning or verification. The tool name display area 302a displays “first tool,” “second tool,” and “third tool” set in the single image 120. In the label information area 302, the setting reception unit 13b accepts user label designations for whether each of the first tool, second tool, and third tool is to be classified as a non-defective product or a defective product. The label corresponding to the first image area 120a is the first label, the label corresponding to the second image area 120b is the second label, and the label corresponding to the third image area 120c is the third label.

The setting reception unit 13b detects that the user has clicked on “first tool” in the tool name display area 302a, and displays the first image area 120a of the single image 120 displayed in the target image area 301 in a form distinguishable from other areas (second image area 120b and third image area 120c). A form distinguishable from other areas includes, for example, coloring the first image area 120a in a color different from other areas, surrounding the first image area 120a with a box, or displaying a name such as “first tool”. In this way, the setting reception unit 13b can superimpose an indicator, such as a box-shaped indicator, indicating the first image area 120a and an indicator, such as a box-shaped indicator, indicating the second image area 120b on the single image 120 in the target image area 301. As a result, the user can easily understand which area of the single image 120 to specify the label for.

Furthermore, the setting reception unit 13b detects that the user has clicked on “second tool” in the tool name display area 302a, and displays the second image area 120b of the single image 120 displayed in the target image area 301 in a form distinguishable from other areas. Furthermore, the setting reception unit 13b detects that the user has clicked on “third tool” in the tool name display area 302a, and displays the third image area 120c of the single image 120 displayed in the target image area 301 in a form distinguishable from other areas.

When specifying the labels for each image region 120a, 120b, and 120c, the user can operate the touch panel 41, keyboard 51, mouse 52, etc. For example, when the user clicks on the label information area 302 corresponding to the first image region 120a, options for non-defective product label and defective product label are displayed. When the user performs an operation to select one of the labels, the selected one becomes valid. If the non-defective product label is selected, it is assumed that the non-defective product label is specified by the user, and the setting reception unit 13b accepts the specification of the non-defective product label as the first label related to the first image region 120a. If the defective product label is selected, it is assumed that the defective product label is specified by the user, and the setting reception unit 13b accepts the specification of the defective product label as the first label related to the first image region 120a. Similarly, the specification of the second label can be accepted for the second image region 120b, and the specification of the third label can be accepted for the third image region 120c. Note that the labels are not limited to non-defective and defective products; for example, it may be possible to specify three or more labels such as Class A, Class B, and Class C.

The setting reception unit 13b temporarily stores a first dataset including a combination of a single image 120 and a first label, a second dataset including a combination of a single image 120 and a second label, and a third dataset including a combination of a single image 120 and a third label. A dataset has multiple combinations of an image and a label based on annotations for that image.

The setting reception unit 13b accepts the specification of a flag indicating whether the combination of the single image 120 and the first label for the first image area 120a corresponding to the first tool is to be used as a learning image included in the first dataset or as a verification image used for performance verification of the first model learned in the first dataset. Specifically, when the user clicks on the learning setting area 302b corresponding to the first tool, options for “learning” and “verification” are displayed. When the user performs an operation to select “learning,” the combination of the single image 120 and the first label for the first image area 120a corresponding to the first tool is set as a learning image included in the first dataset. On the other hand, when the user performs an operation to select “verification,” the combination of the single image 120 and the first label for the first image area 120a corresponding to the first tool is set as a verification image (also referred to as a test image) used for performance verification of the first model learned in the first dataset. This specification of the flag is temporarily stored by the setting reception unit 13b. Similarly, the second tool and the third tool can also accept the specification of the flag.

The labeling user interface screen 300 is provided with a batch learning button 300c. The batch learning button 300c is a button for accepting the execution operation of batch learning to execute the learning of the first model, second model, and third model in a batch. The setting reception unit 13b detects the user's operation of the batch learning button 300c and executes the learning of the first model, second model, and third model in a batch. As mentioned earlier, the dataset includes a combination of multiple images and labels for each of the multiple images. The user can specify the desired label for the image displayed in the target image area 301, and then operate the image feed button 300b to display the next image in the target image area 301, repeating the process of specifying the desired label for the displayed image, thereby specifying labels for multiple images included in the dataset.

For example, the setting reception unit 13b executes learning of the first model related to the first tool executed on the first image area 120a using a first dataset that includes a combination of a single image 120 and the first label. Furthermore, the setting reception unit 13b executes learning of the second model related to the second tool executed on the second image area 120b using a second dataset that includes a combination of a single image 120 and the second label. In addition, when executing learning of the third model related to the third tool executed on the third image area 120c, learning is executed using a third dataset that includes a combination of a single image 120 and the third label. It is not necessary to perform the learning of the first model, the second model, and the third model simultaneously; after the learning of the first model is completed, the learning of the second model may be performed, but in this case, the user only needs to perform one operation, which is to operate the batch learning button 300c. It is also possible for the learning of the first model, the second model, and the third model to be executed sequentially by separate operations by the user.

### (Model Sharing Function)

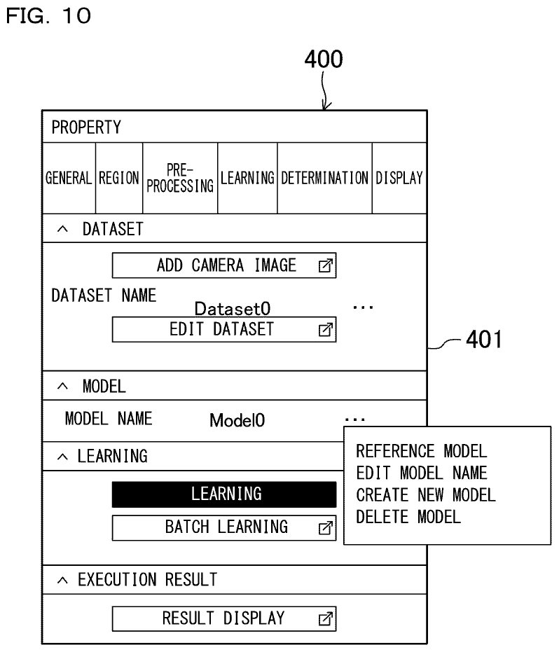

As shown in FIG. 8, when the first model related to the first tool and the second model related to the second tool are models that determine the same thing, the first model and the second model may be the same model. FIG. 10 is a diagram showing an example of a property screen 400 for setting model sharing. The property screen 400 is displayed on the display device 4 when the image inspection apparatus 1 executes the model sharing function. Specifically, when the image inspection apparatus 1 is in a setting mode that accepts various settings from the user, the setting reception unit 13b generates the property screen 400 and causes it to be displayed on the display device 4.

The property screen 400 is provided with a model name display area 401. When the setting reception unit 13b detects that the user has clicked the model name display area 401, it executes a display for setting the reference of the model. Thereafter, the setting reception unit 13b accepts the specification of the model referenced by the second tool as a setting for the second tool, for example. When the first model is specified by the user as the model referenced by the second tool, the second tool executes the first model as the second model. In other words, the first model will be shared between the first tool and the second tool. It is also possible to accept the specification of the model referenced by the third tool as a setting for the third tool, in which case the third tool may execute the first model as the third model.

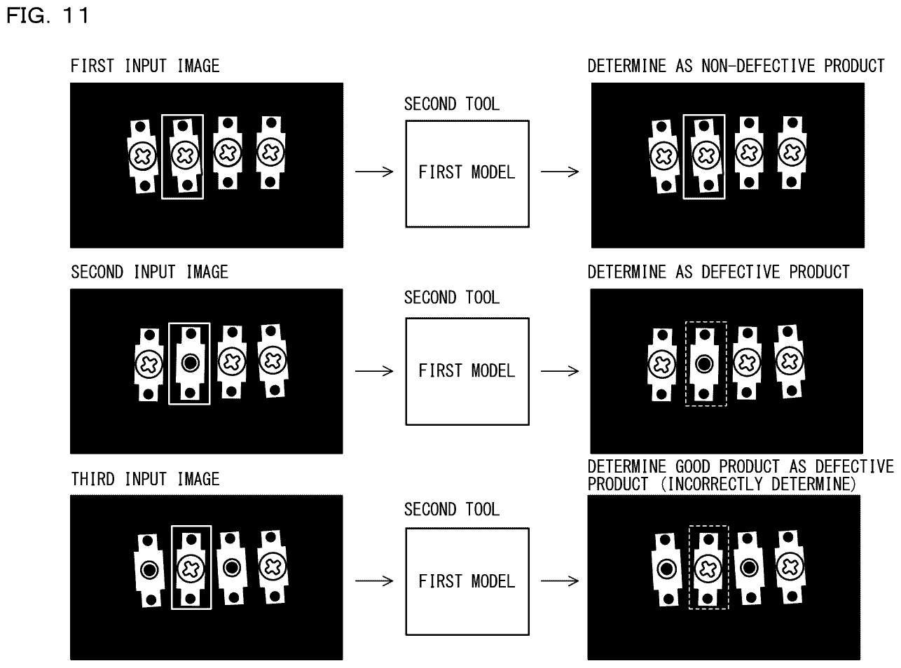

FIG. 11 shows a case where the first model is specified as the model referenced by the second tool. In the example shown at the top of FIG. 11, the first input image is an example of a non-defective product image, and the first model determines the input image to be a non-defective product. In the example shown in the middle of FIG. 11, the second input image is an example of a defective product image, and the first model determines the input image to be a defective product. In the example shown at the bottom of FIG. 11, the third input image is a non-defective product image, but the first model determines the third input image to be a defective product, incorrectly. In this case, the user wants to perform additional learning on the third input image with the second tool.

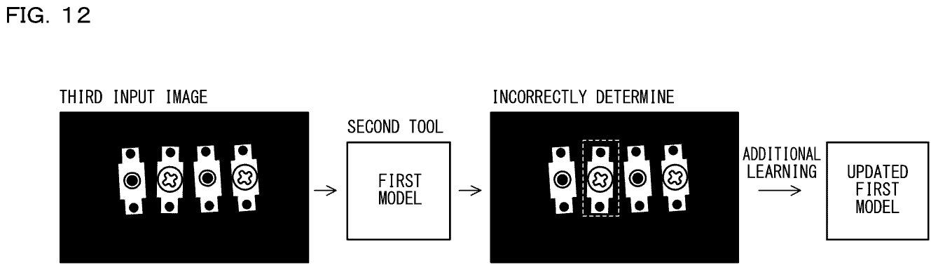

In order to realize this, in this embodiment, as shown in FIG. 12, even when another tool is referencing the first model related to the first tool, it is possible to perform additional learning for the first model from the said another tool.

### (Management of Dataset)

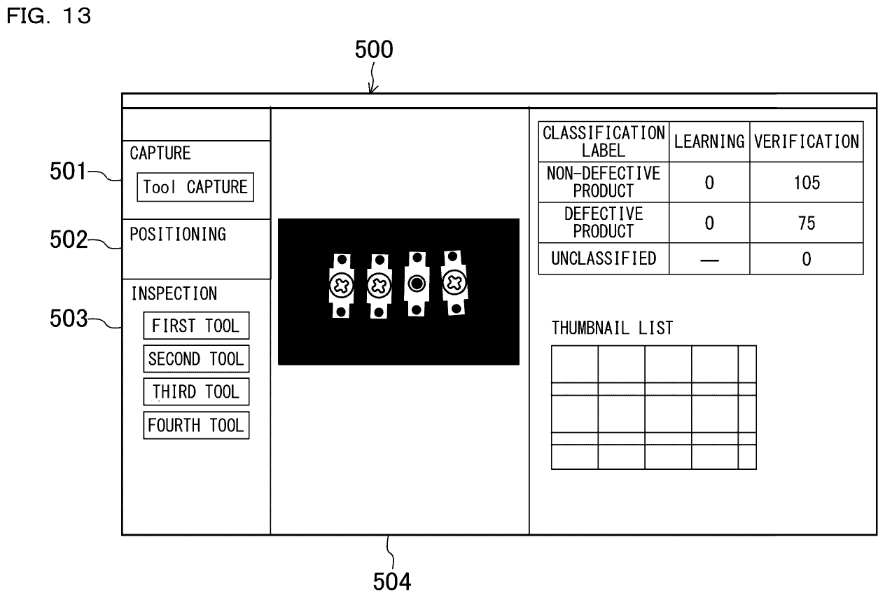

FIG. 13 is a user interface screen 500 for displaying a dataset example of the first tool. The user interface screen 500 for displaying the dataset is provided with an imaging tool display area 501 where the imaging tool is displayed, a positioning tool display area 502 where the positioning tool is displayed, an inspection tool display area 503, and an image display area 504.

The inspection tool display area 503 displays the AI judgment tool. In addition, the image display area 504 displays a single image 120. Since there are four inspection targets in the single image 120, the first tool, second tool, third tool, and fourth tool are set. Among these, the model related to the first tool is the first model, which is a model generated by being learned with the first tool. The first model is shared with other tools and can also be additionally learned from other tools.

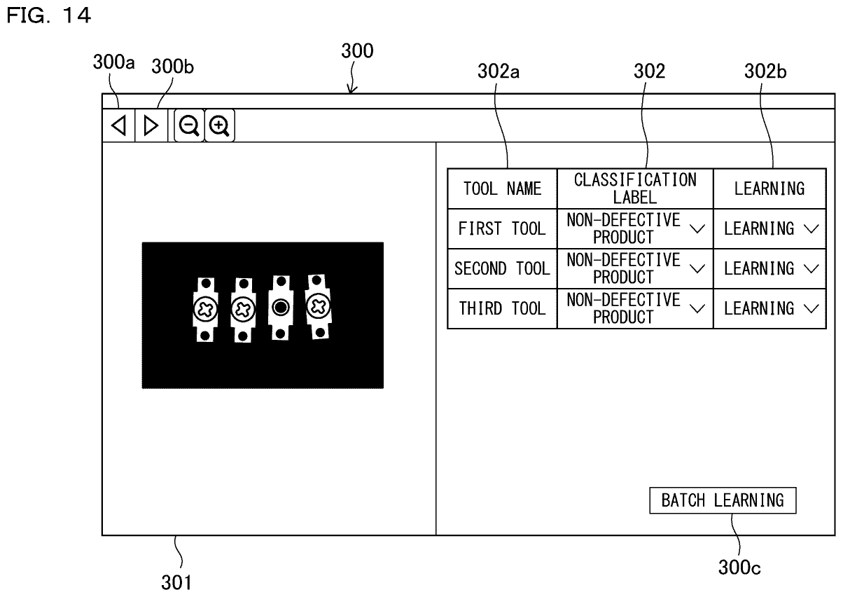

In the example shown in FIG. 13, the label of the first tool is non-defective product, but the label of the third tool needs to be defective product. To solve this problem, as shown in FIG. 14, labeling of non-defective product and defective product is performed in the label information area 302 of the labeling user interface screen 300. This allows for the acceptance of labeling non-defective product and defective product for each tool, enabling additional learning of the model shared from other tools from the respective other tools.

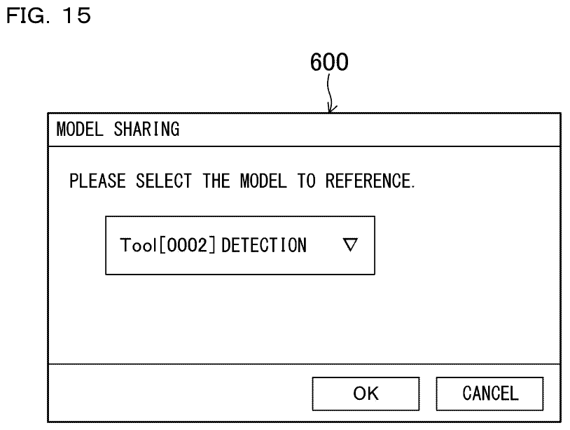

FIG. 15 is a diagram showing an example of a message dialog 600 displayed when sharing a model. That is, for learning a model, it is necessary for the area size to be the same. Therefore, when sharing a model, it is necessary to limit the additional learning to an area of the same size as the source of sharing. When adding a tool, the setting reception unit 13b activates a message dialog 600 as shown in FIG. 15 and displays it on the display device 4, and when sharing a model, the area is restricted.

Furthermore, as another method, it may be possible to set multiple regions with a single tool. For example, when enabling the setting of multiple regions, additional regions can be added. When adding a region, only regions with the same shape and the same size as the first region can be added.

The above-described embodiments are merely illustrative in all respects and should not be interpreted in a limiting manner. Furthermore, any modifications or changes that fall within the equivalent scope of the patent claims are all within the scope of the present disclosure.

As described above, the image inspection apparatus according to this disclosure can be used for inspecting inspection targets such as various parts and products.

What is claimed is:

1. An image inspection apparatus comprising:
an imaging unit configured to capture an image;
an inspection execution unit configured to execute an inspection program for the image captured by the imaging unit; and
a setting reception unit configured to accept a setting related to the inspection program, wherein,
when the setting reception unit accepts the setting related to the inspection program that includes a first tool executed on a first image area of the image and a second tool executed on a second image area different from the first image area, the setting reception unit
displays a setting screen that includes a target image area configured to display the first image area corresponding to the first tool and the second image area corresponding to the second tool based on a single image as the image, in a manner that the first image area and the second image area are specifiable, and a label information area configured to display information of a first label corresponding to the first image area and information of a second label corresponding to the second image area,
accepts a designation of the first label related to the first image area,
accepts a designation of the second label related to the second image area,
executes learning of a first model related to the first tool with a first dataset including a combination of the single image and the first label, and
executes learning of a second model related to the second tool with a second dataset including a combination of the single image and the second label.

2. The image inspection apparatus described in claim 1, wherein:
the setting reception unit displays the target image area based on the image used for the learning of the first model related to the first tool.

3. The image inspection apparatus described in claim 1, wherein:
the first model and the second model are the same model.

4. The image inspection apparatus described in claim 3, wherein:
the setting reception unit accepts a designation of a model referenced by the second tool as a setting for the second tool; and
when the first model is designated as the model referenced by the second tool, the second tool executes the first model as the second model.

5. The image inspection apparatus described in claim 1, wherein:
the setting reception unit accepts a designation of a flag indicating whether a combination of the single image and the first label for the first image area corresponding to the first tool is used as a learning image included in the first dataset or as a verification image used for performance verification of the first model learned in the first dataset, the image inspection apparatus.

6. The image inspection apparatus described in claim 1, wherein:
the setting reception unit displays an indicator indicating the first image area and an indicator indicating the second image area superimposing on the single image in the target image area.

7. The image inspection apparatus described in claim 6, wherein:
the setting reception unit displays the indicator indicating the first image area in a manner different from the indicator indicating the second image area when accepting the designation of the first label.

8. The image inspection apparatus described in claim 1, wherein:
the setting reception unit accepts an execution operation of batch learning that executes the learning of the first model and the second model in a batch.

9. The image inspection apparatus described in claim 1, wherein:
the setting reception unit
accepts an operation to switch an image to be displayed in the target image area to a first image including the first image area and the second image area, and a second image;
displays, in the target image area, a third image area corresponding to the first tool and a fourth image area corresponding to the second tool in a manner that the first image area and the second image area are specifiable;
accepts a designation of a third label related to the third image area;
accepts a designation of a fourth label related to the fourth image area;
executes learning of the first model related to the first tool with a first dataset including the combination of the first image and the first label, and a combination of the second image and the third label;
executes learning of the second model related to the second tool with a second dataset including the combination of the first image and the second label, and a combination of the second image and the fourth label.
